(19) United States
(12) Patent Application Publication
(10) Pub. No.: US 2015/0167589 A1
(43) Pub. Date: Jun. 18, 2015

(54) METHOD AND APPARATUS FOR CONTROLLING HIGH PRESSURE SHUT-OFF VALVE

(71) Applicant: Hyundai Motor Company, Seoul (KR)

(72) Inventor: Sung Ha Lee, Seoul (KR)

(73) Assignee: Hyundai Motor Company, Seoul (KR)

(21) Appl. No.: 14/322,539

(22) Filed: Jul. 2, 2014

(30) Foreign Application Priority Data
Dec. 13, 2013 (KR) 10-2013-0155749

(51) Int. Cl. F02M 21/02; F02D 19/02

(52) U.S. Cl. CPC F02M 21/0245; F02D 19/021

(57) ABSTRACT

Disclosed are an apparatus and a method for controlling an automotive high-pressure shut-off valve. The apparatus may include a high-pressure shut-off valve that is disposed in a high-pressure fuel line and passes or stops fuel flowing through the fuel line depending on whether or not a current is supplied, a switching device that is disposed in a circuit line for allowing the current to flow to the high-pressure shut-off valve and is switchable, and a control unit that variably controls the current flowing through the high-pressure shut-off valve to reduce the current by changing an average voltage applied to the high-pressure shut-off valve through a Pulse Width Modulation (PWM) control on the switching device.

### CROSS-REFERENCE TO RELATED APPLICATION

The present application claims priority of Korean Patent Application Number 10-2013-0155749 filed on Dec. 13, 2013, the entire contents of which application are incorporated herein for all purposes by this reference.

### BACKGROUND OF INVENTION

1. Field of Invention

The present invention relates to a high-pressure shut-off valve in a fuel line, and more particularly, to method and apparatus for controlling an automotive high-pressure shut-off valve which improve the lifespan of a high-pressure shut-off valve by reducing current that is supplied to the high-pressure shut-off valve.

2. Description of Related Art

In vehicles using a gas such as CNG (Compressed Natural Gas) as fuel, a high-pressure shut-off valve is disposed between a fuel tank and a gas pressure regulator and opens or closes a fuel line at high pressure (25˜200 bar).

FIG. 1 is a view illustrating the structure of such a high-pressure shut-off valve, in which in key-off or when an engine stops, the current flowing through the coil covering the high-pressure shut-off valve is stopped and an internal plunger is closed, so that it is possible to prevent unnecessary flow of fuel by stopping the flow of high-pressure fuel and it is also possible to prevent additional fuel leakage even if fuel leaks from a low-pressure fuel line.

Further, in key-on, current is supplied to the coil, a main plunger is opened by force of a solenoid, and a pilot plunger is fully opened and makes fuel smoothly flow after the pressures at the inlet and the outlet reach equilibrium.

Electricity keeps being applied to the coil of the high-pressure shut-off valve to open the high-pressure shut-off valve, as described above.

That is, for commercial vehicles, in key-on, voltage of 24V keeps being supplied to the high-pressure shut-off valve and current of 0.86 A keeps flowing through the coil (28Ω of coil resistance).

Accordingly, the temperature of the coil of the high-pressure shut-off valve is continuously increased and maintained at the level while a vehicle travels, and when this phenomenon keeps for a long period of time, it exerts a bad influence on the durability of the coil and the lifespan of the coil reduces. In particular, there is a defect in the coil of the high-pressure shut-off valve, the high-pressure fuel line is blocked and it causes field problems such as bad engine start.

A “solenoid valve for a vehicle” has been proposed in Korean Patent Publication No. 10-2011-0086350 in the related art.

However, it is difficult to prevent the lifespan of a high-pressure shut-off valve from reducing due to overheating of the coil.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide method and apparatus for controlling an automotive high-pressure shut-off valve which improves the lifespan of a high-pressure shut-off valve by reducing current that is supplied to the high-pressure shut-off valve.

Various aspects of the present invention provide an apparatus for controlling an automotive high-pressure shut-off valve, which may include a high-pressure shut-off valve that is disposed in a high-pressure fuel line and passes or stops fuel flowing through the fuel line depending on whether or not a current is supplied, a switching device that is disposed in a circuit line for allowing the current to flow to the high-pressure shut-off valve and is switchable, and a control unit that variably controls the current flowing through the high-pressure shut-off valve to reduce the current by changing an average voltage applied to the high-pressure shut-off valve through a Pulse Width Modulation (PWM) control on the switching device.

The control unit may control the average voltage and the current applied to the high-pressure shut-off valve to be reduced in accord with the duty ratio of the switching device by reducing the duty ratio to a predetermined range through the PWM control.

The apparatus may further include a relay that is disposed in the circuit line and is to be switched in accord with whether the current is applied, and a relay excitation switch that is electrically connected to the relay and switches to supply or not supply the current to the relay in response to a key-on signal or a key-off signal from the control unit.

Various other aspects of the present invention provide a method of controlling an automotive high-pressure shut-off valve, which may include a control step of variably controlling the current flowing through the high-pressure shut-off valve to be reduced by changing the average voltage applied to the high-pressure shut-off valve through the PWM control on the switching device that is switchable in the circuit line.

The control step may control the average voltage and the current applied to the high-pressure shut-off valve to be reduced in accord with a duty ratio of the switching device by reducing the duty ratio to a predetermined range through the PWM control.

The control step may control the duty ratio such that the average voltage of the high-pressure shut-off valve is kept at above a minimum reference value.

The method may further include, before the control step, a determining step of determining whether or not a key-on signal of a vehicle is inputted, and an initial control step of controlling the average voltage and the current applied to the high-pressure shut-off valve to keep them corresponding to the duty ratio by applying 100% of the duty ratio for a predetermined time through the PWM control on the switching device, if the key-on signal is inputted.

According to the present invention, since the average voltage is reduced and the current flowing through the coil is reduced by changing the voltage between both ends of the high-pressure shut-off valve through PWM control on the switching device, the durability of the coil is improved and the lifespan of the high-pressure shut-off valve is improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other features of the present invention will now be described in detail with reference to certain exemplary embodiments thereof illustrating the accompanying drawings which are given herein below by way of illustration only, and thus are not limitative of the present invention, and wherein:

FIG. 1 is a view illustrating the structure of a high-pressure shut-off valve in a fuel line of a vehicle;

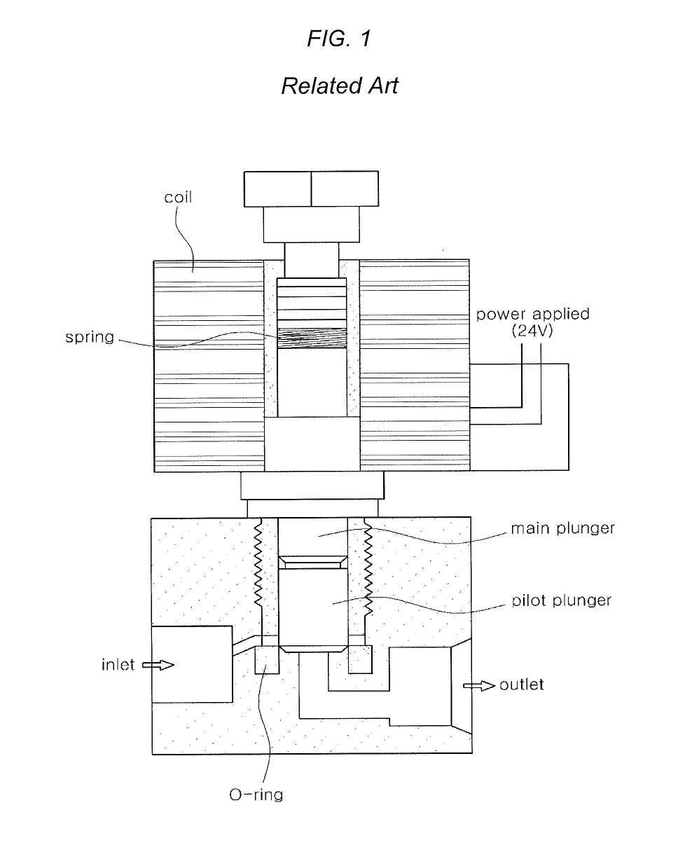

FIG. 2 is a view illustrating a structure of an exemplary apparatus for controlling an automotive high-pressure shut-off valve according to the present invention and an exemplary method of controlling a high-pressure shut-off valve with an exemplary apparatus of the present invention; and

FIG. 3 is a view comparing output values obtained by exemplary method and apparatus for controlling an automotive high-pressure shut-off valve according to the present invention with output values obtained by a high-pressure shut-off valve of the related art.

It should be understood that the appended drawings are not necessarily to scale, presenting a somewhat simplified representation of various preferred features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

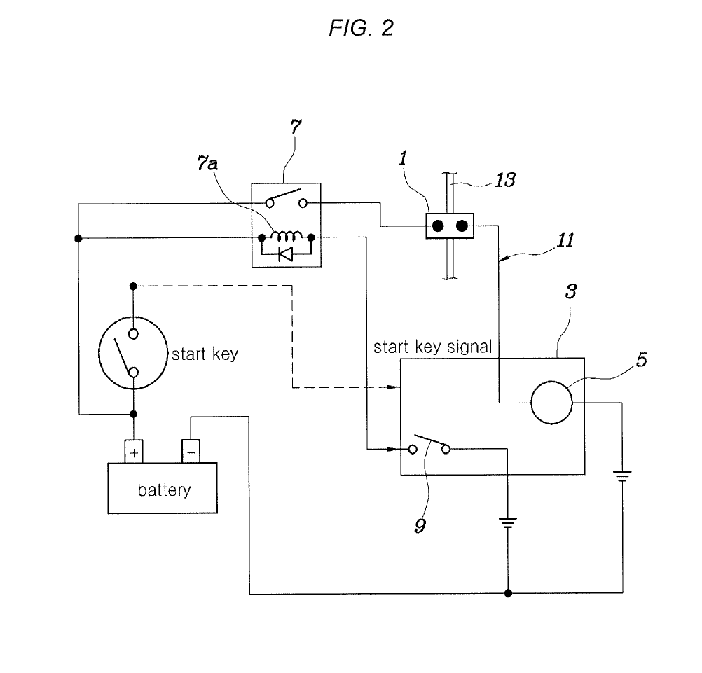

FIG. 2 is a view illustrating a structure of an apparatus for controlling an automotive high-pressure shut-off valve according to various embodiments of the present invention and a method of controlling a high-pressure shut-off valve with an apparatus of the present invention.

An apparatus for controlling an automotive high-pressure shut-off valve according to the preset invention includes a high-pressure shut-off valve 1, a switching device 5, and a control unit 3.

Describing the present invention in detail with reference to FIG. 2, the apparatus includes: the high-pressure shut-off valve 1 that is disposed in a high-pressure fuel line 13 and passes or stops fuel flowing through the fuel line 13, depending on whether current is supplied; the switching device 5 that is disposed in a circuit line 11 for allowing current to flow to the high-pressure shut-off valve 1 and can switch; and the control unit 3 that variably controls the current flowing through the high-pressure shut-off valve 1 to be reduced, by changing the average voltage applied to the high-pressure shut-off valve 1 through PWM control on the switching device 5.

The switching device 5 may be a switch that is electronically controlled.

The control unit 3 may be an Engine Control Unit (ECU), and the anode (+) of the high-pressure shut-off valve 1 is connected to a battery and the cathode (−) of the high-pressure shut-off valve 1 is grounded through the ECU, so that the average voltage is reduced by changing the voltage between both ends of the high-pressure shut-off valve 1 through a Pulse Width Modulation (PWM) control on the switching element 5, and accordingly, the current flowing through the coil reduces.

Therefore, the heat generated by the coil reduces and the durability of the coil is improved, thereby improving the lifespan of the high-pressure shut-off valve 1.

In the present invention, the control unit 3 can control the average voltage and current applied to the high-pressure shut-off valve 1 to be reduced in correspondence to a duty ratio of the switching device 5 by reducing the duty ratio to a predetermined range though the PWM control.

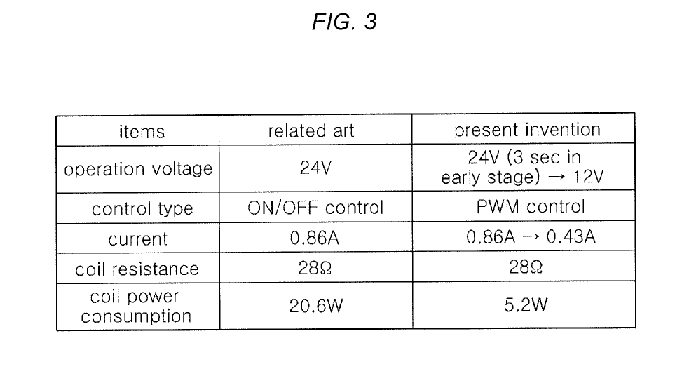

Referring to FIG. 3, when the control unit 3 maintains the duty ratio of the switching device 5 at 100%, the voltage between both ends of the high-pressure shut-off valve 1 is maintained at 24V, but when the duty ratio reduces to 50%, the average voltage of 12V is applied between both ends of the high-pressure shut-off valve 1.

Further, the current flowing through the high-pressure shut-off valve 1 reduces such as to half from 0.86 A to 0.43 A and the power consumption of the coil reduces such as by three quarters from 20.6 W to 5.2 W. Accordingly, the heat generated by the coil also reduces by three quarters and the durability of the coil is improved.

As in FIG. 2, the present invention further includes: a relay 7 that is disposed in the circuit line 11 and can switch in accordance with whether current is applied; and a relay excitation switch 9 that is electrically connected to the relay 7 and switches to supply current to the relay 7 or not in response to a key-on signal or a key-off signal from the control unit 3.

A key-on signal and a key-off signal are inputted to the control unit 3 by a start key and the control unit 3 can determine the key-on signal.

That is, the control unit 3 switches on the relay excitation switch 9, when a key-on signal by the start key is inputted. Then, current is supplied to a relay coil 7a in the relay 7 and the relay coil 7a becomes an electromagnet, and the relay 7 is switched on by the magnetic force of the electromagnet and supplies electricity to the circuit line 11, so that the high-pressure shut-off valve 1 can be electronically controlled.

On the other hand, the present invention relates to a method of controlling the automotive high-pressure shut-off valve 1 and may include a control step of variably controlling current flowing through the high-pressure shut-off valve 1 to be reduced by changing the average voltage applied to the high-pressure shut-off valve 1 through PWM control on the switching device 5 that can switch in the circuit line 11.

The control step can control the average voltage and current applied to the high-pressure shut-off valve 1 to be reduced in correspondence to a duty ratio of the switching device 5 by reducing the duty ratio to a predetermined range though the PWM control.

That is, the average voltage is reduced by changing the voltage between both ends of the high-pressure shut-off valve 1 through the PWM control on the switching device 5, so that the current flowing through the coil reduces. Therefore, the heat generated by the coil reduces and the durability of the coil is improved, thereby improving the lifespan of the high-pressure shut-off valve 1.

In the present invention, the control step can control the duty ratio such that the average voltage of the high-pressure shut-off valve 1 is maintained above the minimum reference value.

That is, once the high-pressure shut-off valve 1 opens, it can keep open unless the supplied power drops close to 0V. Accordingly, when the minimum reference value is set to the minimum average voltage at which the high-pressure shut-off valve 1 does not close after opening, the current flowing through the high-pressure shut-off valve 1 is further reduced and the durability of the coil can be further increased.

The method of the present invention may include, before the control step, a determining step of determining a key-on signal of a vehicle and an initial control step of controlling the average voltage and current applied to the high-pressure shut-off valve 1 to keep them corresponding to the duty ratio by applying 100% of duty ratio for a predetermined time through PWM control on the switching device 5, when the key-on signal is inputted.

That is, the engine of a vehicle is started with the duty ratio of the switching device 5 maintained at 100% for about 3 seconds at the early stage of starting the engine, so that the opening characteristic of the high-pressure shut-off valve 1 at the early stage of starting an engine is kept and deterioration of ability of starting the engine of a vehicle is prevented.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling an automotive high-pressure shut-off valve, comprising:
a high-pressure shut-off valve that is disposed in a high-pressure fuel line and passes or stops fuel flowing through the fuel line, depending on whether or not a current is supplied;
a switching device that is disposed in a circuit line for allowing the current to flow to the high-pressure shut-off valve and is switchable; and
a control unit that variably controls the current flowing through the high-pressure shut-off valve to reduce the current, by changing an average voltage applied to the high-pressure shut-off valve through a Pulse Width Modulation (PWM) control on the switching device.

2. The apparatus of claim 1, wherein the control unit controls the average voltage and the current applied to the high-pressure shut-off valve to be reduced in accord with a duty ratio of the switching device by reducing the duty ratio to a predetermined range through the PWM control.

3. The apparatus of claim 1, further comprising:
a relay that is disposed in the circuit line and is to be switched in accord with whether the current is applied; and
a relay excitation switch that is electrically connected to the relay and switches to supply or not supply the current to the relay in response to a key-on signal or a key-off signal from the control unit.

4. A method of controlling the automotive high-pressure shut-off valve of claim 1, the method comprising:
a control step of variably controlling the current flowing through the high-pressure shut-off valve to be reduced by changing the average voltage applied to the high-pressure shut-off valve through the PWM control on the switching device that is switchable in the circuit line.

5. The method of claim 4, wherein the control step controls the average voltage and the current applied to the high-pressure shut-off valve to be reduced in accord with a duty ratio of the switching device by reducing the duty ratio to a predetermined range through the PWM control.

6. The method of claim 5, wherein the control step controls the duty ratio such that the average voltage of the high-pressure shut-off valve is kept at above a minimum reference value.

7. The method of claim 4, further comprising: before the control step,
a determining step of determining whether or not a key-on signal of a vehicle is inputted; and
an initial control step of controlling the average voltage and the current applied to the high-pressure shut-off valve to keep them corresponding to the duty ratio by applying 100% of the duty ratio for a predetermined time through the PWM control on the switching device, if the key-on signal is inputted.
